(19) United States
(12) Patent Application Publication
(10) Pub. No.: US 2025/0197272 A1
(43) Pub. Date: Jun. 19, 2025

(54) OPTICAL FIBER MANUFACTURING METHOD

(71) Applicant: SUMITOMO ELECTRIC INDUSTRIES, LTD., Osaka-shi, Osaka (JP)

(72) Inventors: Yuzuki KOBAYASHI, Osakai-shi, Osaka (JP); Shinji NAKAHARA, Osaka-shi, Osaka (JP)

(21) Appl. No.: 18/877,614

(22) PCT Filed: Jun. 16, 2023
(86) PCT No.: PCT/JP2023/022403

§ 371 Date: Dec. 20, 2024

(30) Foreign Application Priority Data
Jun. 21, 2022 (JP) 2022-099385

(51) Int. Cl. C03B 37/027; C03B 37/03; C03B 37/035

(52) U.S. Cl. CPC C03B 37/02727; C03B 37/032; C03B 37/035

(57) ABSTRACT

An optical fiber manufacturing method uses a drawing furnace configured to heat and soften a glass preform and an annealing furnace disposed downstream of the drawing furnace and configured to gradually cool a glass fiber drawn from the drawing furnace to manufacture an optical fiber including the glass fiber. The optical fiber manufacturing method includes: manufacturing the optical fiber; and completing the manufacturing of the optical fiber. The completing the manufacturing of the optical fiber includes: cleaving the glass fiber at a downstream side of the annealing furnace; decreasing an internal temperature of the annealing furnace to an annealing point of the glass fiber or lower after the cleaving the glass fiber at the downstream side; and removing the glass fiber from the annealing furnace after decreasing the internal temperature.

### TECHNICAL FIELD

The present disclosure relates to an optical fiber manufacturing method.

The present application is based on and claims priority to Japanese Patent Application No. 2022-099385 filed on Jun. 21, 2022, the entire contents of which are incorporated herein by reference.

### BACKGROUND ART

As an optical fiber manufacturing method of manufacturing an optical fiber from a glass preform, there is a known optical fiber manufacturing method using a drawing furnace that heats and softens a glass preform and an annealing furnace that is disposed below the drawing furnace and gradually cools a glass fiber drawn from the drawing furnace (for example, see Patent Literature 1).

In such an optical fiber manufacturing device, when the manufacturing of an optical fiber is completed, the process proceeds from a drawing process for manufacturing the optical fiber to a drawing completion process for completing the manufacturing of the optical fiber.

In the drawing completion process, a glass fiber, which is an intermediate product during the manufacturing of the optical fiber, is removed from the optical fiber manufacturing device at an upstream side of the annealing furnace while maintaining a temperature of the annealing furnace at the same level as in the drawing process.

### CITATION LIST

### Patent Literature

Patent Literature 1: JP2010-168247A

### SUMMARY OF INVENTION

An optical fiber manufacturing method according to the present disclosure is an optical fiber manufacturing method using a drawing furnace configured to heat and soften a glass preform and an annealing furnace disposed downstream of the drawing furnace and configured to gradually cool a glass fiber drawn from the drawing furnace to manufacture an optical fiber including the glass fiber, the optical fiber manufacturing method including: a drawing process for manufacturing the optical fiber; and a drawing completion process for completing the manufacturing of the optical fiber, in which the drawing completion process includes: a fiber downstream cleaving step of cleaving the glass fiber at a downstream side of the annealing furnace; a temperature decreasing step of decreasing an internal temperature of the annealing furnace to an annealing point of the glass fiber or lower after the fiber downstream cleaving step; and a fiber removing step of removing the glass fiber from the annealing furnace after the temperature decreasing step.

### BRIEF DESCRIPTION OF DRAWINGS

FIG. 1 is a schematic diagram illustrating an optical fiber manufacturing device according to an aspect of the present disclosure.

FIG. 2 is a flowchart of an optical fiber manufacturing method according to an aspect of the present disclosure.

FIG. 3 is a flowchart of a drawing completion process shown in FIG. 2.

FIG. 4A is a diagram illustrating cleaving of a glass fiber at a downstream side of an annealing furnace.

FIG. 4B is a diagram illustrating cleaving of the glass fiber at an upstream side of the annealing furnace.

FIG. 4C is a diagram illustrating a situation in which an upstream end of the glass fiber is marked.

FIG. 4D is a diagram in which the glass fiber is removed from the annealing furnace.

FIG. 5A is a diagram illustrating a situation in which an upstream end of a glass fiber is marked according to a modification.

FIG. 5B is a diagram illustrating cleaving of the glass fiber at an upstream side of an annealing furnace according to the modification.

### DESCRIPTION OF EMBODIMENTS

### Problem to be Solved by Present Disclosure

In the drawing completion process in the related art described above, the glass fiber may remain in the annealing furnace, and it is necessary to periodically clean the inside of the annealing furnace, or a glass fiber being drawn may come into contact with the glass fiber remaining in the annealing furnace and break during the next manufacturing of the optical fiber.

Therefore, the present disclosure has been made to solve the problems of the related art as described above, that is, an object of the present disclosure is to provide an optical fiber manufacturing method in which a glass fiber piece is less likely to adhere to an inner surface of an annealing furnace in a drawing completion process.

### Advantageous Effects of Present Disclosure

According to the above, the glass fiber piece can be made less likely to remain in the annealing furnace in the drawing completion process.

### Description of Embodiment of Present Disclosure

First, an embodiment of the present disclosure will be listed and described.

The optical fiber manufacturing method according to the present disclosure is (1) an optical fiber manufacturing method using a drawing furnace configured to heat and soften a glass preform and an annealing furnace disposed downstream of the drawing furnace and configured to gradually cool a glass fiber drawn from the drawing furnace to manufacture an optical fiber including the glass fiber, the method including: a drawing process for manufacturing the optical fiber; and a drawing completion process for completing the manufacturing of the optical fiber, in which the drawing completion process includes: a fiber downstream cleaving step of cleaving the glass fiber at a downstream side of the annealing furnace; a temperature decreasing step of decreasing an internal temperature of the annealing furnace to an annealing point of the glass fiber or lower after the fiber downstream cleaving step; and a fiber removing step of removing the glass fiber from the annealing furnace after the temperature decreasing step.

According to the optical fiber manufacturing method configured as described above, the drawing completion process includes the temperature decreasing step. Consequently, since the glass fiber is removed from the annealing furnace in a state where the internal temperature of the annealing furnace is decreased to the annealing point of the glass fiber or lower and the viscosity of the glass fiber decreases, when the glass fiber is removed from the annealing furnace, the glass fiber is less likely to adhere to an inner surface of the annealing furnace, and it is possible to reduce the frequency of cleaning the annealing furnace and reduce occurrence of breakage of the optical fiber during the drawing process.

Here, the annealing point of glass (that is, the glass fiber and the glass preform) is a temperature at which the viscosity of the glass is 10¹² [Pa·s], and is a temperature at which the strain inside the glass can be removed in about 15 minutes.

In a temperature range in which a temperature of a surface of the glass fiber is higher than the annealing point of the glass, a viscous flow of the surface of the glass fiber increases. Therefore, when the glass fiber comes into contact with the inside of the annealing furnace, it is considered that a shape of the surface of the glass fiber changes, and the glass fiber is likely to adhere to the inside of the annealing furnace.

Therefore, by setting the temperature of the surface of the glass fiber to a temperature range equal to or lower than the annealing point of the glass, it is considered that the viscous flow of the glass fiber becomes extremely slow, and thus, the glass fiber is less likely to adhere to the inside of the annealing furnace even when the glass fiber comes into contact with the inside of the annealing furnace.

Therefore, the glass fiber is removed from the annealing furnace after the internal temperature of the annealing furnace is decreased to the annealing point of the glass fiber or lower.
(2) In the optical fiber manufacturing method described above, in the fiber removing step, the glass fiber is pulled out from below the annealing furnace and removed from the annealing furnace.

Accordingly, a length of the glass fiber that may come into contact with the annealing furnace when the glass fiber is pulled out from the annealing furnace is shorter than that in a case where the glass fiber is pulled out from above the annealing furnace and removed from the annealing furnace. Thus, when the glass fiber is removed from the annealing furnace, the glass fiber can be made less likely to adhere to the inner surface of the annealing furnace.

In addition, since a direction in which the glass fiber is pulled out from the annealing furnace is opposite to a direction in which an ascending airflow generated inside the annealing furnace flows, when the glass fiber is removed from the annealing furnace, the posture of the glass fiber is stabilized by the ascending airflow, and the glass fiber can be made even less likely to adhere to the inner surface of the annealing furnace.
(3) In the optical fiber manufacturing method described above, the drawing completion process includes a fiber upstream cleaving step of cleaving the glass fiber at an upstream side of the annealing furnace after the temperature decreasing step and before the fiber removing step.

Accordingly, when the glass fiber is removed from the annealing furnace, a tip of the glass fiber extending from the glass preform is positioned upstream of the annealing furnace, and thus, when the manufacturing of the optical fiber is completed, the glass fiber can be reliably prevented from remaining on the inner surface of the annealing furnace.
(4) In the optical fiber manufacturing method described above, the drawing completion process includes a marking step of marking the glass fiber at the upstream side of the annealing furnace after the fiber downstream cleaving step and before the fiber upstream cleaving step, and a marked portion of the glass fiber is cleaved in the fiber upstream cleaving step.

Accordingly, when the glass fiber is pulled out from the annealing furnace, whether the glass fiber is cleaved while the glass fiber is pulled out from the annealing furnace is determined by checking whether there is a marking on a rear end of the pulled-out glass fiber, and thus, it is possible to easily check whether the glass fiber is pulled out from the annealing furnace without remaining.
(5) In the optical fiber manufacturing method described above, the drawing completion process includes a marking step of marking an upstream end of the glass fiber separated from the glass preform after the fiber upstream cleaving step.

Accordingly, when the glass fiber is pulled out from the annealing furnace, whether the glass fiber is cleaved while the glass fiber is pulled out from the annealing furnace is determined by checking whether there is a marking on a rear end of the pulled-out glass fiber, and thus, it is possible to easily check whether the glass fiber is pulled out from the annealing furnace without remaining.
(6) In the optical fiber manufacturing method described above, the marking is application of a paint to an upstream end of the glass fiber.

Accordingly, an outer diameter of the glass fiber is less likely to be increased than in a case where a tape is attached to the upstream end of the glass fiber as the marking on the upstream end of the glass fiber, and thus, the glass fiber is less likely to be entangled when the glass fiber is removed from the annealing furnace, and the glass fiber can be easily removed from the annealing furnace.

### Details of Embodiment of Present Disclosure

Hereinafter, a specific example of the optical fiber manufacturing method according to the present disclosure will be described.

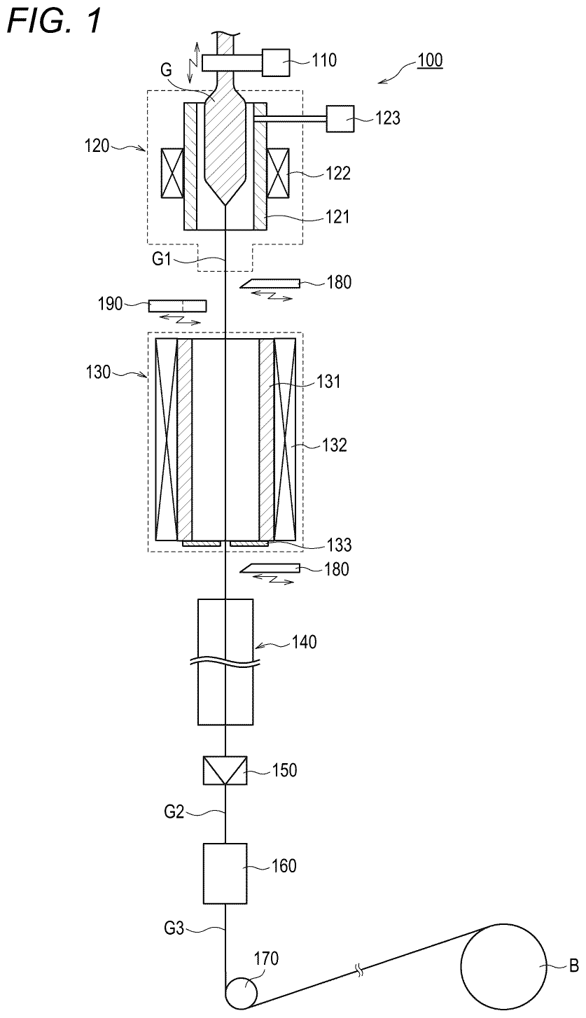

First, an optical fiber manufacturing device 100 will be described with reference to FIG. 1 showing an example of the optical fiber manufacturing device 100.

### 1. Configuration of Optical Fiber Manufacturing Device

As shown in FIG. 1, the optical fiber manufacturing device 100 includes, in order from the most upstream side, a preform feeding unit 110 that grips an upper portion of a glass preform G, a drawing furnace 120 that heats and softens the glass preform G, an annealing furnace 130 that gradually cools a glass fiber G1 drawn from the drawing furnace 120, a forced cooling unit 140 that forcibly cools the glass fiber G1 passing through the annealing furnace 130, a resin coating die 150 that applies ultraviolet curing resin (hereinafter, referred to as UV curing resin) to the glass fiber G1 passing through the forced cooling unit 140 to produce a resin-coated fiber G2, a UV curing furnace 160 that cures the UV curing resin applied to a surface of the resin-coated fiber G2 to produce an optical fiber G3, and an under roller 170 that changes a running direction of the optical fiber G3 toward a bobbin B around which the optical fiber G3 is wound.

As shown in FIG. 1, the optical fiber manufacturing device 100 further includes a fiber cleaving means 180 that cleaves the glass fiber G1 at an upstream side or at a downstream side of the annealing furnace 130, a fiber gripping means 190 that grips the glass fiber G1 at an downstream side of the drawing furnace 120 and at an upstream side of the annealing furnace 130, and a controller (not shown) that controls each of the elements of the optical fiber manufacturing device 100.

As shown in FIG. 1, the preform feeding unit 110 grips the upper portion of the glass preform G, and can freely pull up or lower the glass preform G with respect to the drawing furnace 120.

The drawing furnace 120 includes a cylindrical furnace core tube 121 to an inner side of which the glass preform G is supplied, a heating element 122 surrounding the furnace core tube 121, and a gas supply unit 123 that supplies inert gas into the furnace core tube 121.

The heating element 122 may be a resistance furnace or an induction furnace.

The annealing furnace 130 includes a cylindrical furnace core tube 131 to an inner side of which the glass preform G is supplied, a heating element 132 surrounding the furnace core tube 131, and a shutter 133 that opens and closes the furnace core tube 131.

Similarly to the heating element 122 of the drawing furnace 120, the heating element 132 may be a resistance furnace or an induction furnace.

When the annealing furnace is provided downstream of the drawing furnace, the glass fiber is not rapidly cooled to about room temperature but is gradually cooled to about room temperature in a stepwise manner, and thus, the Rayleigh scattering intensity is reduced and the transmission loss of the optical fiber is reduced.

In the forced cooling unit 140, cooling gas such as helium gas is supplied from a gas supply source (not shown), and the glass fiber G1 drawn from the glass preform G is forcibly cooled by the cooling gas.

The resin coating die 150 stores the UV curing resin for protecting the glass fiber.

The UV curing furnace 160 includes a cylindrical quartz tube, a light source disposed outside the quartz tube, and a reflecting mirror that converges ultraviolet rays emitted from the light source onto the resin-coated fiber G2.

The under roller 170 is disposed directly below the drawing furnace 120, and the running direction of the optical fiber G3 is changed from a vertical direction to, for example, an obliquely upward direction.

### 2. Manufacture of Optical Fiber Using Optical Fiber Manufacturing Device

Next, an optical fiber manufacturing method by the optical fiber manufacturing device 100 will be described in detail with reference to FIGS. 1 to 4D.

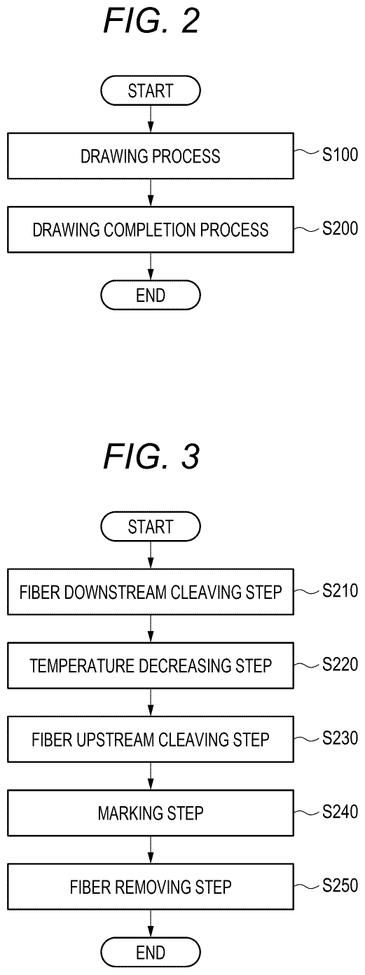

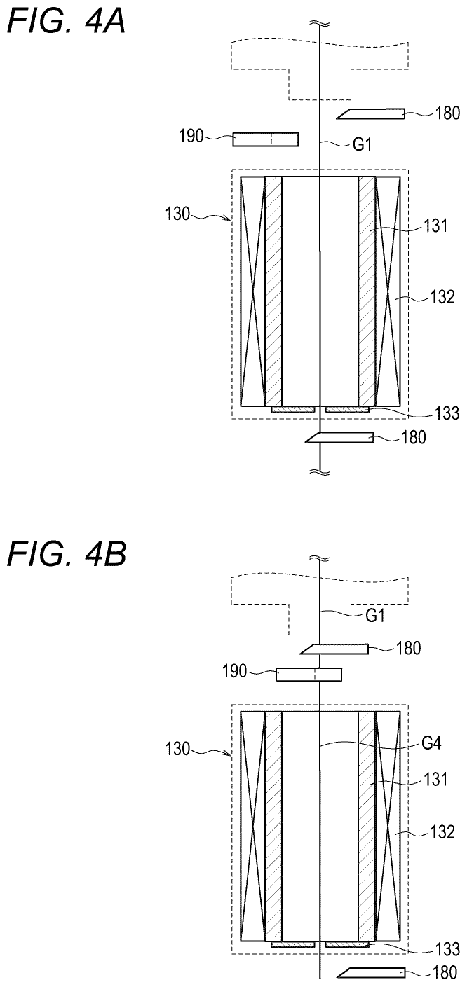

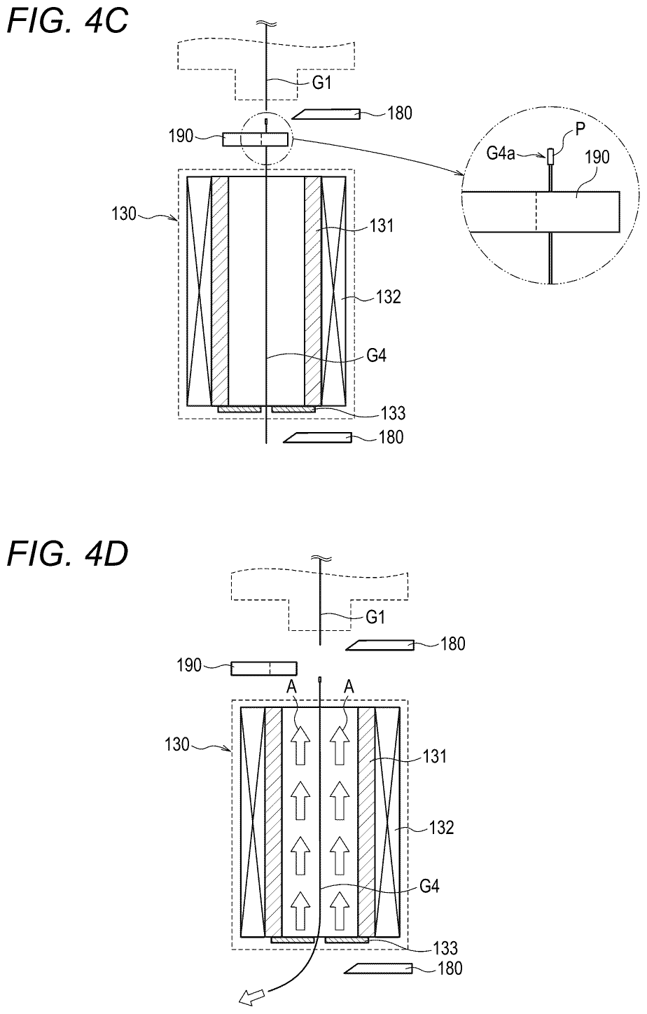

FIG. 2 is a flowchart of an optical fiber manufacturing method according to an aspect of the present disclosure, FIG. 3 is a flowchart of a drawing completion process illustrated in FIG. 2, FIG. 4A is a diagram illustrating cleaving of a glass fiber at the downstream side of an annealing furnace, FIG. 4B is a diagram illustrating cleaving of the glass fiber at the upstream side of the annealing furnace, FIG. 4C is a diagram illustrating a situation in which an upstream end of the glass fiber is marked, and FIG. 4D is a diagram in which the glass fiber is removed from the annealing furnace.

As shown in FIG. 2, the optical fiber manufacturing method by the optical fiber manufacturing device 100 includes a drawing process S100 for manufacturing the optical fiber G3, and a drawing completion process S200 for completing the manufacturing of the optical fiber G3 following the drawing process $100.

### 2.1. Drawing Process

First, the drawing process S100 will be described with reference to FIG. 1.

In the drawing process S100, the glass preform G is fed into the furnace core tube 121 of the drawing furnace 120 by the preform feeding unit 110.

When a lower end portion of the glass preform G is softened by the heating of the furnace core tube 121 by the heating element 122 and drawn downward, the glass fiber G1 constituting the optical fiber G3 is formed.

The glass fiber G1 has a core portion and a cladding portion, and is an optical waveguide having an outer diameter of, for example, 125 μm.

Then, the glass fiber G1 drawn from the glass preform G passes through the annealing furnace 130 having a lower temperature (for example, 1200° C.) than the drawing furnace 120, so that a temperature of a surface of the glass fiber G1 is gradually decreased.

The glass fiber G1 is gradually cooled in the annealing furnace 130, and then passes through the forced cooling unit 140, whereby the temperature of the surface of the glass fiber G1 is decreased to about room temperature.

When the glass fiber G1 cooled to about room temperature passes through the resin coating die 150, the UV curing resin is applied around the glass fiber G1 to form the resin-coated fiber G2.

When the resin-coated fiber G2 passes through the UV curing furnace 160, the UV curing resin applied to the surface of the glass fiber G1 is irradiated with ultraviolet rays in the UV curing furnace 160 and cured, thereby producing the optical fiber G3.

The optical fiber G3 whose running direction is changed by the under roller 170 is wound around the bobbin B.

### 2.2. Drawing Completion Process

Next, the drawing completion process S200 will be described with reference to FIGS. 1, 3, 4A to 4D, and the like.

As shown in FIG. 3, the drawing completion process S200 includes a fiber downstream cleaving step S210, a temperature decreasing step S220, a fiber upstream cleaving step S230, a marking step S240, and a fiber removing step S250.

In the fiber downstream cleaving step S210, the glass fiber G1 is cleaved at the downstream side of the annealing furnace 130 and at the upstream side of the resin coating die 150.

Then, in the fiber downstream cleaving step S210, as shown in FIG. 4A, the glass fiber G1 is cleaved by the fiber cleaving means 180 at the downstream side of the annealing furnace 130 and at the upstream side of the resin coating die 150.

The temperature decreasing step S220 is executed after the fiber downstream cleaving step S210.

Then, in the temperature decreasing step S220, an internal temperature of the annealing furnace 130 is decreased to an annealing point of the glass preform G or lower (for example, 1000° C. or lower).

The fiber upstream cleaving step S230 is executed after the temperature decreasing step S220.

In the fiber upstream cleaving step S230, as shown in FIG. 4B, the glass fiber G1 is cleaved by the fiber cleaving means 180 upstream of the fiber gripping means 190 in a state where the glass fiber G1 is gripped by the fiber gripping means 190 downstream of the drawing furnace 120 and upstream of the annealing furnace 130.

Accordingly, when the glass fiber G1 is removed from the annealing furnace 130, a tip of the glass fiber G1 extending from the glass preform G is positioned upstream of the annealing furnace 130, and thus, when the manufacturing of the optical fiber G3 is completed, the glass fiber G1 can be reliably prevented from remaining on an inner surface of the annealing furnace 130.

The marking step S240 is executed after the fiber upstream cleaving step S230. Then, in the marking step S240, as shown in FIG. 4C, an upstream end G4a of a glass fiber G4 separated from the glass preform G is marked (a white paint P is applied).

Accordingly, when the glass fiber G4 separated from the glass preform G is pulled out from the annealing furnace 130, whether the glass fiber G4 is cleaved while the glass fiber G4 is pulled out from the annealing furnace 130 is determined by checking whether there is a marking on a rear end of the pulled-out glass fiber G4, and thus, it is possible to easily check whether the glass fiber G4 is pulled out from the annealing furnace 130 without remaining.

In addition, since an outer diameter of the glass fiber G4 is less likely to be increased than in a case where a tape is attached to the upstream end G4a of the glass fiber G4 separated from the glass preform G as the marking on the upstream end of the glass fiber G4, the glass fiber G4 is less likely to be entangled when the glass fiber G4 separated from the glass preform G is removed from the annealing furnace 130, and the glass fiber G4 can be easily removed from the annealing furnace 130.

The fiber removing step S250 is executed after the marking step S240.

Then, in the fiber removing step S250, as shown in FIG. 4D, the glass fiber G4 separated from the glass preform G is pulled out from below the annealing furnace 130 and removed from the annealing furnace 130.

In the drawing completion process S200 executed as described above, since the glass fiber G1 is removed from the annealing furnace 130 in a state where the internal temperature of the annealing furnace 130 is decreased to the annealing point of the glass fiber G1 or lower and the viscosity of the glass fiber G1 decreases, when the glass fiber G1 is removed from the annealing furnace 130, the glass fiber G1 is less likely to adhere to the inner surface of the annealing furnace 130, reducing the frequency of cleaning the annealing furnace 130 and reducing breakage of the optical fiber G3 during the drawing process.

Since a length of the glass fiber G4 that may come into contact with the annealing furnace 130 when the glass fiber G4 separated from the glass preform G is pulled out from the annealing furnace 130 is shorter than that in a case where the glass fiber G4 is pulled out from above the annealing furnace 130 and removed from the annealing furnace 130, when the glass fiber G4 separated from the glass preform G is removed from the annealing furnace, the glass fiber G4 can be made less likely to adhere to the inner surface of the annealing furnace 130.

In addition, since a direction in which the glass fiber G4 separated from the glass preform G is pulled out from the annealing furnace is opposite to a direction A in which an ascending airflow generated inside the annealing furnace 130 flows, when the glass fiber G4 separated from the glass preform G is removed from the annealing furnace 130, the posture of the glass fiber G4 is stabilized by the ascending airflow, and the glass fiber G4 can be made even less likely to adhere to the inner surface of the annealing furnace 130.

### Modification

Although an embodiment of the present disclosure has been described above, the present disclosure is not limited thereto.

In addition, elements included in the embodiment described above can be combined as long as it is technical possible, and a combination thereof is also included in the scope of the present invention as long as the features of the present invention are included.

For example, in the embodiment described above, the annealing furnace 130 includes one furnace core tube 131 and one heating element 132, but may include a plurality of furnace core tubes and heating elements.

When the annealing furnace includes a plurality of furnace core tubes and heating elements, it is preferable to gradually decrease the temperature of the heating elements from upstream to downstream.

For example, the fiber cleaving means 180 in the embodiment described above may be any means such as a cutter or scissors as long as the glass fiber G1 can be cleaved.

In the embodiment described above, the fiber cleaving means 180 cleaves the glass fiber G1, but the glass fiber G1 may be cleaved by any means, and is not limited to the fiber cleaving means 180 of the optical fiber manufacturing device 100, such as cleaving by an operator.

For example, the fiber gripping means 190 in the embodiment described above may be any means as long as the glass fiber G1 can be gripped.

In addition, in the embodiment described above, the fiber gripping means 190 grips the glass fiber G1, but the glass fiber G1 may be gripped by any means, and is not limited to the fiber gripping means 190 of the optical fiber manufacturing device 100, such as gripping by an operator.

For example, in the embodiment described above, the white paint P is applied as the marking on the glass fiber G1, but the color of the paint to be applied to the glass fiber G1 is not limited to white.

In addition, the marking on the glass fiber G1 is not limited to the application of the paint, and may be, for example, attachment of a tape.

For example, in the embodiment described above, the temperature decreasing step S220 is executed after the fiber downstream cleaving step S210, but the execution timing of the temperature decreasing step is not limited thereto, and for example, the temperature decreasing step may be executed before the fiber downstream cleaving step S210.

For example, in the embodiment described above, in the temperature decreasing step S220, the internal temperature of the annealing furnace is decreased to the annealing point of the glass fiber or lower, but the internal temperature of the annealing furnace may be decreased to a strain point of the glass fiber or lower.

Here, the strain point of the glass is a temperature at which the viscosity of the glass is 10^{13.5} [Pa·s], and at this temperature, no viscous flow virtually occurs, and it is considered that the strain in the glass cannot be removed at this temperature or lower.

Therefore, in a temperature range in which the temperature of the surface of the glass fiber is between the strain point and the annealing point of the glass, a viscous flow occurs, but is extremely slow. Thus, as in a case where the temperature is equal to or lower than the strain point temperature, it is considered that the glass fiber is less likely to adhere to the inside of the annealing furnace even when the glass fiber comes into contact with the inside of the annealing furnace.

In addition, in a temperature range in which the temperature of the surface of the glass fiber is equal to or lower than the strain point of the glass, even when the glass fiber comes into contact with the inside of the cooling furnace, it is considered that the glass fiber does not adhere to the inside of the annealing furnace as when solid bodies come into contact with each other.

Therefore, by decreasing the internal temperature of the annealing furnace to the strain point of the glass fiber or lower, the glass fiber can be more reliably prevented from adhering to the inner surface of the annealing furnace.

For example, in the embodiment described above, the marking step S240 is executed after the fiber upstream cleaving step S230, but the execution timing of the marking step is not limited thereto, and for example, the marking step may be executed after the fiber downstream cleaving step S210 and before the fiber upstream cleaving step S230.

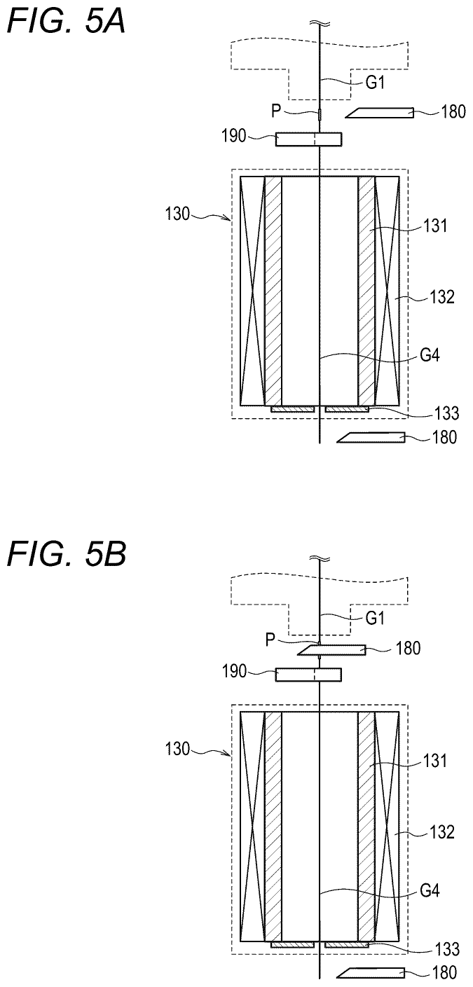

In this case, after the fiber downstream cleaving step S210 is executed, the marking step is executed as shown in FIG. 5A, and the marked portion of the glass fiber G1 is cleaved in the fiber upstream cleaving step S230 as shown in FIG. 5B.

When the marking step is executed after the fiber downstream cleaving step S210 and before the fiber upstream cleaving step S230, the marking step may be executed after the temperature decreasing step S220 or the temperature decreasing step S220 may be executed after the marking step.

For example, in the fiber removing step S250 of the embodiment described above, the glass fiber G4 separated from the glass preform G is pulled out from below the annealing furnace 130 and removed from the annealing furnace 130, but the glass fiber G4 separated from the glass preform G may be pulled out from above the annealing furnace 130 and removed from the annealing furnace 130.

### REFERENCE SIGNS LIST

100: optical fiber manufacturing device
110: preform feeding unit
120: drawing furnace
121: furnace core tube
122: heating element
123: gas supply unit
130: annealing furnace
131: furnace core tube
132: heating element
133: shutter
140: forced cooling unit
150: resin coating die
160: UV curing furnace
170: under roller
180: fiber cleaving means
190: fiber gripping means
B: bobbin
G: glass preform
G1: glass fiber
G2: resin-coated fiber
G3: optical fiber
G4: glass fiber separated from glass preform
G4a: upstream end of glass fiber separated from glass preform
P: white paint
A: direction of ascending airflow

What is claimed is:

1. An optical fiber manufacturing method using a drawing furnace configured to heat and soften a glass preform and an annealing furnace disposed downstream of the drawing furnace and configured to gradually cool a glass fiber drawn from the drawing furnace to manufacture an optical fiber including the glass fiber, the optical fiber manufacturing method comprising:
manufacturing the optical fiber; and
completing the manufacturing of the optical fiber, wherein
the completing the manufacturing of the optical fiber comprises:
cleaving the glass fiber at a downstream side of the annealing furnace;
decreasing an internal temperature of the annealing furnace to an annealing point of the glass fiber or lower after the cleaving the glass fiber at the downstream side; and
removing the glass fiber from the annealing furnace after decreasing the internal temperature.

2. The optical fiber manufacturing method according to claim 1,
wherein in the removing the glass fiber, the glass fiber is pulled out from below the annealing furnace and removed from the annealing furnace.

3. The optical fiber manufacturing method according to claim 2,
wherein the completing the manufacturing of the optical fiber comprises cleaving the glass fiber at an upstream side of the annealing furnace after the decreasing the internal temperature and before the cleaving the glass fiber at the downstream side.

4. The optical fiber manufacturing method according to claim 3,
wherein the completing the manufacturing of the optical fiber comprises marking the glass fiber at the upstream side of the annealing furnace after the cleaving the glass fiber at the downstream side and before the cleaving the glass fiber at the upstream side, and
wherein a marked portion of the glass fiber is cleaved in the cleaving the glass fiber at the upstream side.

5. The optical fiber manufacturing method according to claim 3,
wherein the completing the manufacturing of the optical fiber comprises marking an upstream end of the glass fiber separated from the glass preform after the cleaving the glass fiber at the downstream side.

6. The optical fiber manufacturing method according to claim 4,
wherein the marking comprises application of a paint to an upstream end of the glass fiber.

7. The optical fiber manufacturing method according to claim 5,
wherein the marking comprises application of a paint to an upstream end of the glass fiber.
